(19) United States
(12) Patent Application Publication
(10) Pub. No.: US 2014/0191171 A1
(43) Pub. Date: Jul. 10, 2014

(54) LAWN MOWER LIFTING MACHINE

(71) Applicant: SHANGHAI CARTEC INDUSTRIAL AND TRADING CO., LTD., Shanghai (CN)

(72) Inventor: Bin LIN, Shanghai (CN)

(73) Assignee: SHANGHAI CARTEC INDUSTRIAL AND TRADING CO., LTD, Shanghai (CN)

(21) Appl. No.: 13/761,775

(22) Filed: Feb. 7, 2013

(30) Foreign Application Priority Data
Jan. 9, 2013 (CN) 201310007091.7

(51) Int. Cl. B66F 5/04

(52) U.S. Cl. CPC B66F 5/04
USPC 254/2 B

(57) ABSTRACT

A lawn mower lifting machine includes a frame, a power device, a lifting device, a limit device and a support device. The frame includes a bottom frame and a jack installing board frame. The power device includes a jack with the top coupled to the lifting device and the bottom coupled to the frame. The lifting device includes a lift arm coupled between the frame and the power device. The limit device includes a brake block, a limit rack and a retractor coupled to the lifting device. The retractor can be turned to hook the brake block. The support device includes a lift beam, a lift frame coupled to both sides of the lift beam.

### FIELD OF THE INVENTION

The present invention relates to a lawn mower lifting machine, in particular to a handy lawn mower lifting machine with a reliable position limiting effect.

### BACKGROUND OF THE INVENTION

Lawn mower, also known as grass remover, grass cutter, and grass trimmer, is a semi-automatic mechanical tool used for trimming and cutting grass and plants, and this tool requires maintenance and repair from time to time due to its frequent use.

In the process of maintaining and repairing the lawn mower, it is necessary to use a specific lifting device to lift the lawn mower. General vertical hydraulic jacks or horizontal hydraulic jacks available in the market for repairing cars provide a limited lifting height only and cannot lift the lawnmower to a required height for the repair. In addition, the aforementioned hydraulic jacks only come with a single lifting point, so that the lifting is unstable, and these hydraulic jacks cannot provide a safe way of lifting the lawn mower.

Some car lifting machines used in garages can be used for the purpose of repairing the lawn mower, but these machines are heavy and large and cannot be moved easily, and the lawn mower must be transported to a place where these machines are situated before the lawn mower can be repaired. Obviously, it is very inconvenient.

### SUMMARY OF THE INVENTION

Therefore, it is a primary objective of the present invention to provide a handy lawn mower lifting machine with a reliable position limiting effect.

To achieve the aforementioned objective, the present invention provides a lawn mower lifting machine comprising a frame, a power device, a lifting device, a limit device and a support device.

The frame is composed of a bottom frame and a jack installing board.

The body of the power device is a jack with a base mounted onto a jack installing board of the frame, and the top end of a piston of the jack is coupled to a lift trolley of the lifting device.

The lifting device comprises a lift trolley, a lift arm and a driven rod, wherein ends of the lift arm and the driven rod are installed to the frame and the other ends of the lift arm and the driven rod are coupled to a lift beam of the support device; and the lift trolley is hinged to the lift arm.

The limit device is composed of a brake block and a limit rack, wherein the brake block is hinged to the lift trolley.

The support device includes a lift beam and a tire lifting frame disposed on both sides of the support device, and the tire lifting frame is installed at both ends of the lift beam.

In a preferred embodiment of the aforementioned lawn mower lifting machine, the limit device is comprised of a brake block, a limit rack and a retractor.

In the aforementioned lawn mower lifting machine, the brake block is comprised of a main beam, two side plates and a limit plate. An included angle of 120˜150° is formed between the limit plate disposed at the top end of the main beam and the main beam, and both sides of the main beam are fixed to the two side plates respectively, and each of the two side plates has a bolt hole; the brake block is hinged to the lift trolley; the lift trolley is a door-shaped structure comprised of a crossbeam and vertical plates disposed on both sides, and two perforated lugs are disposed below the middle of the crossbeam; the brake block is hinged to the lift trolley by passing a bolt through bolt holes of the two side plates and through holes of two perforated lugs of the door-shaped structure of the lift trolley and sheathing a self-locking nut on a threaded end of the bolt.

In the aforementioned lawn mower lifting machine, the limit rack is fixed to the jack installing board which is formed by engaging two boards and has a cross-section in an inverted L-shape, wherein one of the boards facing the rear is used for installing the jack, and the other board facing the front is fixed to the limit rack; the limit rack has a plurality of horizontally arranged rectangular teeth or saw-shaped teeth, and the number of teeth ranges from 1 to 4.

In the aforementioned lawn mower lifting machine, the front end of the retractor is a hook, and the rear end of the retractor is a retaining ring; the lift trolley has a perforated retractor holder, and the retaining ring at the rear end of the retractor is buckled into a hole of the retractor holder; and the brake block has a retractor hole formed on a side plate of the brake block.

In the aforementioned lawn mower lifting machine, the tire lifting frame includes a tire frame and a coupling bar, and the tire frame is rectangular frame formed by a triangular plate, two inverted V-shaped angle bars arranged opposite to each other and a connecting rod, and the coupling bar is perpendicularly fixed to an external side of the triangular plate of the tire frame.

In the aforementioned lawn mower lifting machine, the coupling bar is a square pipe having 3 to 8 positioning holes formed at the vertical and horizontal directions of the coupling bar respectively.

In the aforementioned lawn mower lifting machine, the lift beam is a steel channel having a plurality of tire frame positioning holes formed at the vertical and horizontal directions of the lift beam respectively.

In the aforementioned lawn mower lifting machine, after the positioning holes of the coupling bar and the tire frame positioning holes of the lift beam are aligned, a bolt or an insert pin is used for positioning.

In the aforementioned lawn mower lifting machine, the jack is a hydraulic jack comprising a jack body, a pedal coupled to the jack body by screws, and an unloading springboard coupled to the jack body by insert pins, and the jack is mounted to the jack installing board by screws, and the unloading springboard has a safety R pin.

In the aforementioned lawn mower lifting machine, the top of the piston of the jack is coupled to the lift trolley of the lifting device by means of a through hole formed at the top end of the piston of the jack, and the lift trolley is a door-shaped structure comprised of a crossbeam and a vertical plate disposed on both sides, and two perforated lugs are disposed under the middle of the crossbeam, and the piston of the jack is situated at the middle of the two perforated lugs of the door-shaped structure of the lift trolley, and a bolt is passed through the through hole formed at the top end of the piston of the jack and the two perforated lugs of the lift trolley door-shaped structure, and a self-locking nut is sheathed on a threaded end of the bolt.

In the aforementioned lawn mower lifting machine, the lift arm, the driven rod, the lift beam and the frame lifting device constitute a parallelogram.

In the aforementioned lawn mower lifting machine, the lift arm is an H-shaped structure comprised of two lift rods and a crosspiece, and the lift rod has a reinforcing plate installed thereon and a lift trolley installing hole formed on the reinforcing plate, and a through hole is formed separately at both ends of the lift rod.

In the aforementioned lawn mower lifting machine, the lift trolley is a door-shaped structure comprised of a crossbeam and a vertical plate disposed separately on both sides of the lift trolley, and a through hole is formed at a distal end of the vertical plate.

In the aforementioned lawn mower lifting machine, the driven rod is installed on both sides, such that each lift rod operates with a corresponding driven rod, and the driven rod has a through hole formed separately at both ends of the driven rod.

In the aforementioned lawn mower lifting machine, the lift trolley installing hole and the through holes at distal ends of the vertical plates are coupled by a pin shaft or a bolt to hinge the lift trolley to the lift arm.

In the aforementioned lawn mower lifting machine, the lift beam has two perforated lift arms disposed at both distal sides of the lug respectively, and the through hole at the top end of the lift rod of the lift arm and the hole of the lug of the perforated lift arm on a side of the lift beam are hinged by a pin shaft or a bolt.

In the aforementioned lawn mower lifting machine, a driven rod lug is disposed under each end of the lift beam, and the driven rod lug has a pin shaft, and the through hole formed at the top end of the driven rod is sheathed on the pin shaft and limited by the elastic snap ring.

In the aforementioned lawn mower lifting machine, the frame is a rectangular frame with a fixed beam added in the middle, and the jack installing board is formed by engaging two boards and has a cross-section in an inverted L-shape, and one of the boards facing the rear is used for installing the jack and has a jack installing screw hole formed thereon, and the other board facing the front is fixed to the limit rack, and an end of the jack installing board is fixed to the fixed beam and the other end of the jack installing board is fixed onto the rectangular frame of the frame, and a wheel is installed on both left and right sides of the rear of the rectangular frame of the frame, and mounted to the frame by bolts, and a gasket is included between the wheel and the bolt, and a lift arm installing holder which is a rectangular block installed separately on both left and right sides of the frame and has a lift arm installing hole formed at the middle, and a driven rod installing hole is formed separately on both sides of the frame.

In the aforementioned lawn mower lifting machine, the door-shaped structure of the lift trolley has a trolley hole formed at the middle, a pin hole disposed laterally with respect to the trolley hole, and a through hole is formed at an end of the trolley, such that the trolley can be inserted into the trolley hole, and the insert pin is inserted into the pin hole of the trolley hole and the through hole of the trolley, and a safety R pin is provided for locking, and a handlebar is perpendicularly installed at the other end of the trolley, and the trolley is situated precisely at the center of the handlebar, and a handle sleeve is sheathed separately at both ends of the handlebar.

The lawn mower lifting machine of the present invention is operated according to a procedure as described below.

Check if the movable parts of the lifting machine are operated normally, and make sure the retractor is not hooked to the brake block.

Push the two front wheels of the lawn mower safely onto the tire lifting frame of the machine Make sure the load is situated at the middle without shifting to a side. Loosen the brake of the lawn mower lifting machine, and set the clutch to neutral.

Step on the pedal by a foot to lift up the jack, so that the lifting structure will lift up the tire lifting frame.

Check whether the final lifting height is secured at a height of a gear, such that the bottom of the brake block must be abutted against one of the limit racks on the base.

Perform the repair work of the lawn mower.

Step on the pedal by foot for a coupled of times again to descend the lawn mower lifting machine after the repair, so that the brake block no longer abuts against the limit rack, and use the retractor to hook the brake block, so that the brake block is completely separated from the limit rack.

Press the unloading springboard by foot, and slowly descend the lawn mower lifting machine.

The lawn mower lifting machine of the present invention has advantages including simple and light structure, highly secured locking mechanism, safe and reliable securing effect, substantially vertical support to prevent malfunction caused by mechanical fatigue, and long-term lifting and locking functions. In addition, the height of the machine can be fixed automatically by the weight of the machine during braking. The hook can be used to hook the brake block and stop the lifting in a descending process effectively, and the lift frame can be adjusted flexibly according to the width of the tire lifting frame. Therefore the lawn mower lifting machine of the present invention can be applicable for various lawn mowers of different specifications.

### BRIEF DESCRIPTION OF THE DRAWINGS

FIG. 1 is a schematic view of a lawn mower lifting machine of the present invention;

FIG. 2 is an exploded view of a lawn mower lifting machine of the present invention;

FIG. 3 is a schematic view of a frame of the present invention;

FIG. 4 is an exploded view of a power device of the present invention;

FIG. 5 is an exploded view of a lifting device of the present invention;

FIG. 6 is a schematic view of a lift arm of the present invention;

FIG. 7 is a schematic view of a lift trolley of the present invention;

FIG. 8 is a schematic view of an assembly of a brake block of the present invention;

FIG. 9 is a schematic view of a support device of the present invention; and

FIG. 10 is a schematic view of a lift frame of the present invention.

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

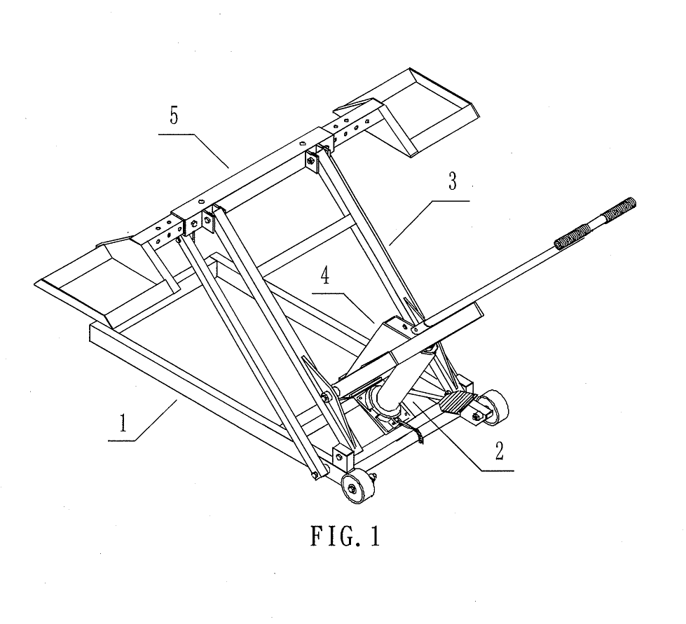

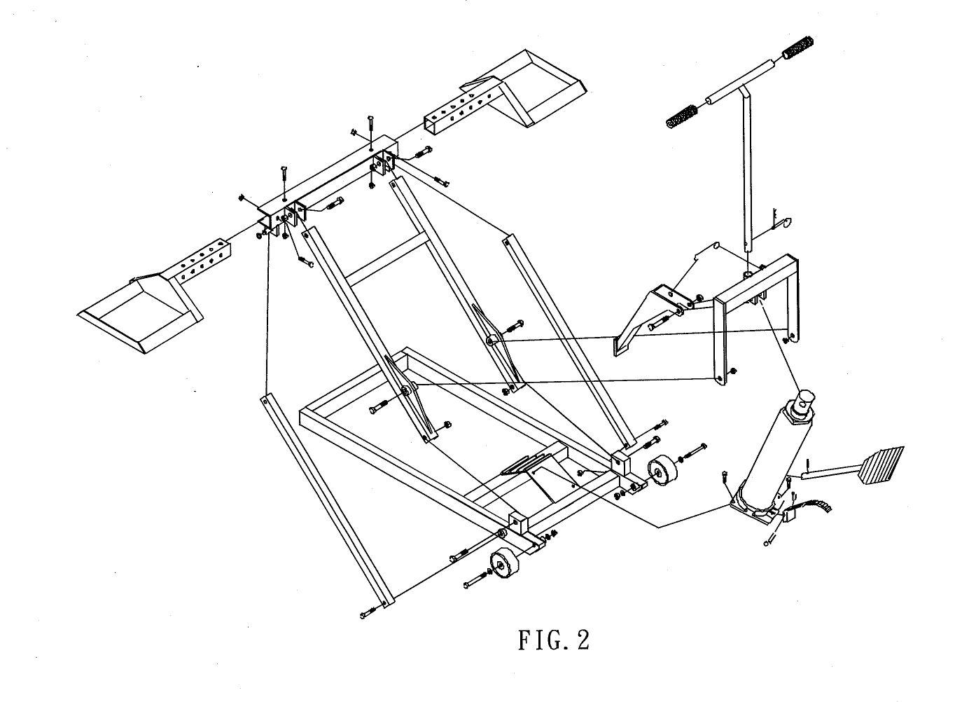

With reference to FIGS. 1 and 2 for a lawn mower lifting machine of the present invention, the lawn mower lifting machine comprises a frame 1, a power device 2, a lifting device 3, a limit device 4 and a support device 5.

The frame is comprised of a bottom frame and a jack installing board 102.

The body of the power device 2 is a jack, and the jack has a base mounted onto a jack installing board 102 of the frame, and the top end of a piston of the jack is coupled to a lift trolley 301 of the lifting device 3.

The lifting device 3 comprises a lift trolley 301, a lift arm 302 and a driven rod 303. Ends of the lift arm 302 and the driven rod 303 are installed to the frame 1, and other ends of the lift arm 302 and the driven rod 303 are coupled to a lift beam 501 of the support device 5, and the lift trolley 301 is hinged to the lift arm 302.

The limit device 4 comprises a brake block 401 and a limit rack 104, wherein the brake block 401 is hinged to the lift trolley 301.

The support device 5 comprises a lift beam 501 and a tire lifting frame 502 disposed on both sides of the support device 5, and the tire lifting frame 502 is installed at both ends of the lift beam 501.

The limit device 4 comprises a brake block 401, a limit rack 104 and a retractor 402.

In FIG. 8, the brake block 401 comprises a main beam, two side plates and a limit plate, wherein the limit plate disposed at the top end of the main beam and the main beam form an included angle of 120˜150°, and both sides of the main beam are fixed to the two side plates respectively, and each of the two side plates has a bolt hole. The brake block 401 is hinged to the lift trolley 301. The lift trolley 301 is a door-shaped structure comprised of a crossbeam 301a, a vertical plate 301b disposed separately on both sides of the lift trolley 301, and two perforated lugs 301c disposed under the middle of the crossbeam 301a. The brake block 401 is hinged by passing a bolt through bolt holes of the two side plates and through holes of two perforated lugs of the door-shaped structure of the lift trolley and sheathing a self-locking nut on a threaded end of the bolt. The limit rack 104 is fixed to the jack installing board 102 which is formed by engaging two boards, and the jack installing board 102 has a cross-section in an inverted L-shape. Wherein, one of the boards facing the rear is used for installing the jack, and the other board facing the front is fixed to the limit rack 104; the limit rack 104 has a plurality of horizontally arranged rectangular teeth or saw-shaped teeth, and the number of teeth ranges from 1 to 4.

The front end of the retractor 402 is a hook, and the rear end of the retractor 402 is a retaining ring. The lift trolley 301 has a perforated retractor holder 301d, and the retaining ring at the rear end of the retractor 402 is buckled into a hole of the retractor holder 301d; and the brake block 401 has a retractor hole formed on a side plate of the brake block 401.

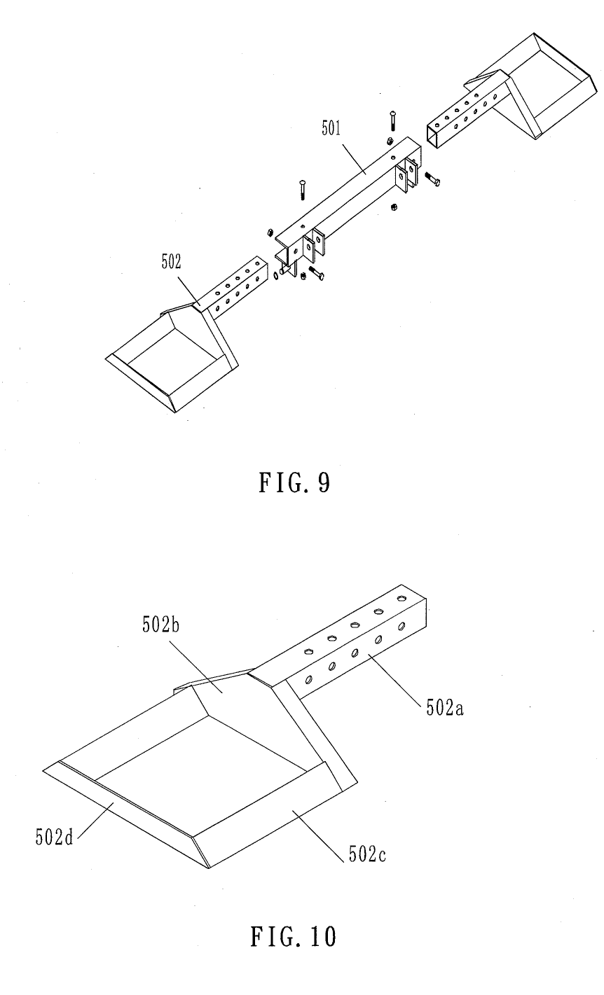

In FIGS. 9 and 10, the tire lifting frame 502 comprises a tire frame and a coupling bar 502a, wherein the tire frame is a rectangular frame formed by a triangular plate 502b, two inverted V-shaped angle bars 502c arranged opposite to each other and a connecting rod 502d. The coupling bar 502a is perpendicularly fixed to an external side of the triangular plate 502b of the tire frame.

The coupling bar 502a is a square pipe having 3 to 8 positioning holes formed at the vertical and horizontal directions of the coupling bar respectively

The lift beam 501 is a steel channel having a plurality of tire frame positioning holes formed at the vertical and horizontal directions of the lift beam respectively.

After the positioning holes of the coupling bar 502a and the tire frame positioning holes of the lift beam 501 are aligned, a bolt or an insert pin is used for positioning.

The jack is a hydraulic jack comprising a jack body 201, a pedal coupled to the jack body by screws 203, and an unloading springboard 205 coupled to the jack body 201 by insert pins 206. The jack is mounted to the jack installing board 102 by screws 203, and the unloading springboard 205 has a safety R pin 204 as shown in FIG. 4.

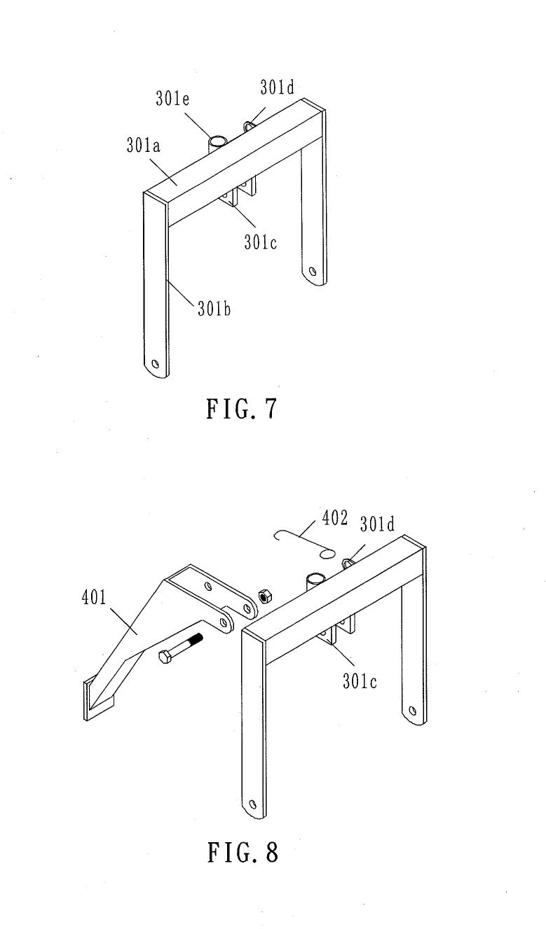

The top of the piston of the jack is coupled to the lift trolley 301 of the lifting device 3 by means of a through hole formed at the top of the piston of the jack, and the lift trolley 301 is a door-shaped structure comprised of a crossbeam 301a and a vertical plate 301b disposed separately on both sides, and two perforated lugs 301c are disposed under the middle of the crossbeam 301a as shown in FIG. 7, and the piston of the jack is disposed at the middle of door-shaped structure of the lift trolley 301 and the two perforated lugs 301c. A bolt is passed through the through hole at the top of the piston of the jack and the two perforated lugs 301c of the door-shaped structure of the lift trolley 301, and finally a self-locking nut is sheathed on a threaded end of the bolt.

With reference to FIG. 5 for an exploded view of a lifting device of the present invention, the lift arm 302, the driven rod 303, the lift beam 501 and the frame 1 of the lifting device 3 form a parallelogram.

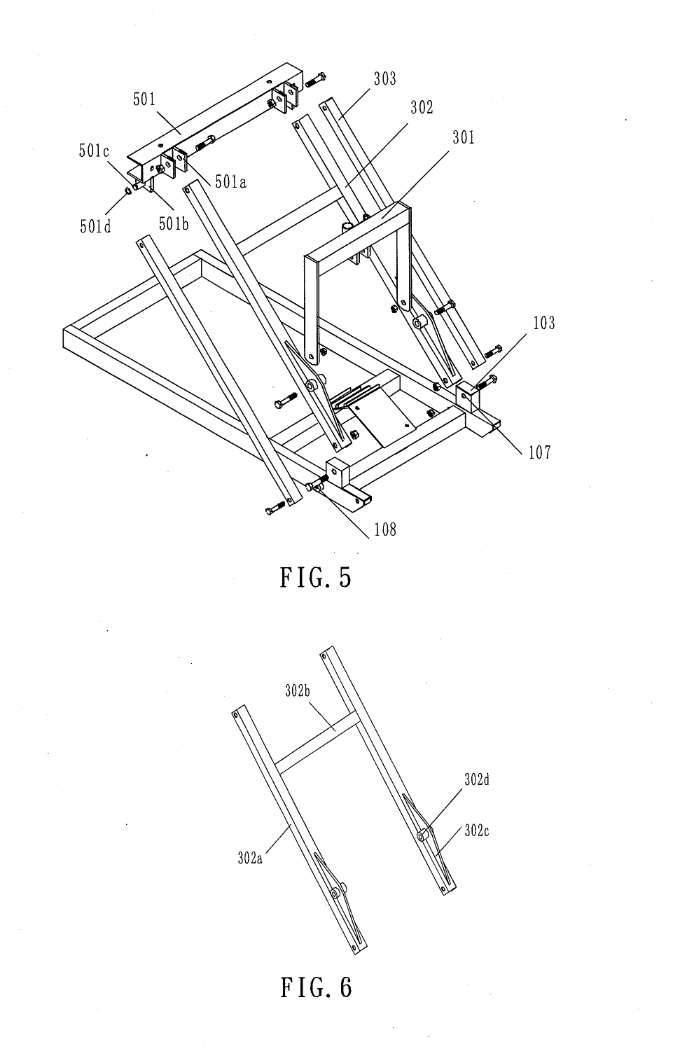

The lift arm 302 is a H-shaped structure comprised of two lift rods 302a and a crosspiece 302b, and the lift rod 302a includes a reinforcing plate 302c installed thereon, and the reinforcing plate 302c has a lift trolley installing hole 302d formed thereon, and a through hole is formed separately at both ends of the lift rod 302a as shown in FIG. 6.

The lift trolley 301 is door-shaped structure comprises of a crossbeam 301a and vertical plates 301b on both sides of the cross-beam 301a, and a through hole is formed at a distal end of the vertical plate 301b as shown in FIG. 7.

The driven rod 303 is installed separately on both sides. In other words, each lift rod 302a has a corresponding driven rod 303, and a through hole is formed separately at both ends of the driven rod 303.

The lift trolley installing hole 302d and the through hole at the distal end of the vertical plate 301b are coupled by a pin shaft or a bolt to hinge the lift trolley 301 to the lift arm 302.

Two perforated lift arm lugs 501a are disposed at both ends of the lift beam 501 respectively, and the through hole at the top end of the lift rod 302a of the lift arm 302 and a hole of the perforated lift arm lug 501a on a side of the lift beam 501 are hanged by a pin shaft or a bolt.

A driven rod lug 501b is disposed under each of the ends of the lift beam 501, and the driven rod lug 501b has a pin shaft 501c installed thereon, and the through hole formed at the top end of the driven rod 303 is sheathed on the pin shaft 501c and limited by an elastic snap ring 501d.

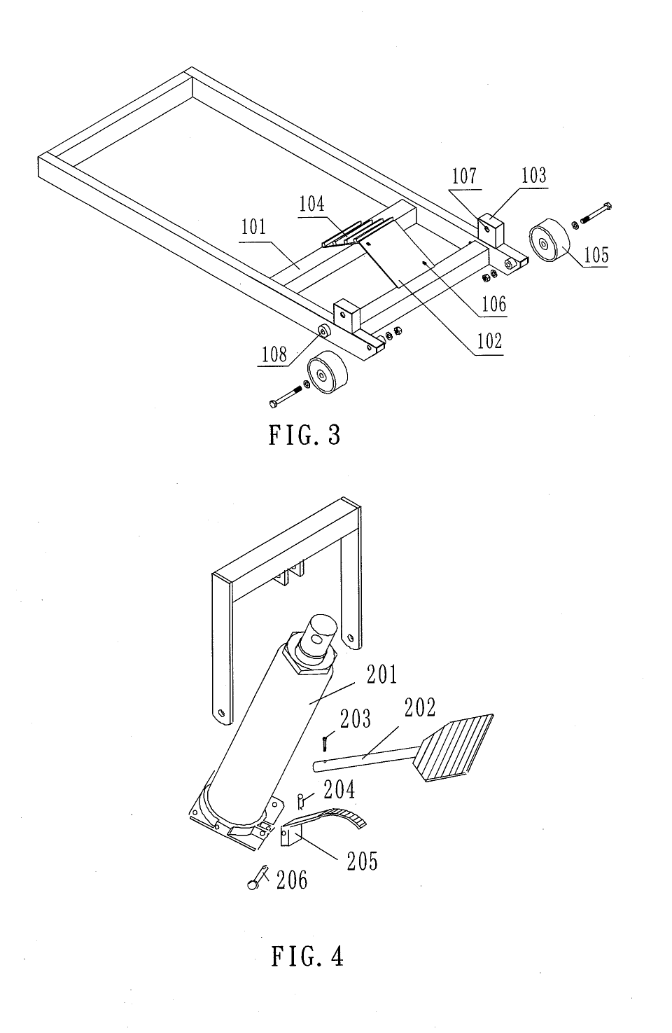

In FIG. 3, the frame 1 is a rectangular frame having a fixed beam 101 added in the middle of the frame 1, and the jack installing board 102 is formed by engaging two boards and has a cross-section in an inverted L-shape, wherein one of the boards facing the rear is used for installing the jack and has a jack installing screw hole 106 formed thereon, and the other board facing the front is fixed to the limit rack 104. An end of the jack installing board 102 is fixed to the fixed beam 101, and the other end of the jack is fixed to the rectangular frame of the frame 1. A wheel 105 is installed on both left and right sides of the rear of the rectangular frame of the frame 1 and the wheel 105 is installed to the frame 1 by bolts, and a gasket is included between the wheel 105 and the bolt. A lift arm installing holder 103 is disposed separately on both left and right sides of the frame 1, wherein the lift arm installing holder 103 is a rectangular block with a lift arm installing hole 107 formed at the middle. A driven rod installing hole 108 is formed separately on both left and right sides of the frame 1.

A trolley hole 301e is formed at the middle of the door-shaped structure of the lift trolley 301, and a pin hole is formed laterally with respect to the trolley hole 301e, and a through hole is formed at an end of the trolley. The trolley can be inserted into the trolley hole 301e, and an insert pin can be inserted into the pin hole of the trolley hole 301e and the through hole of the trolley, and a safety R pin is used for locking. A handlebar is vertically installed at the other end of the trolley, and the trolley is disposed precisely at the center of the handlebar, and a handle sleeve is sheathed separately on both ends of the handlebar.

What is claimed is:

1. A lawn mower lifting machine, comprising a frame, a power device, a lifting device, limit device and a support device, characterized in that the frame is composed of a bottom frame and a jack installing board; the body of the power device is a jack with a base mounted onto a jack installing board of the frame, and the top end of a piston of the jack is coupled to a lift trolley of the lifting device; the lifting device comprises a lift trolley, a lift arm and a driven rod, wherein ends of the lift arm and the driven rod are installed to the frame and the other ends of the lift arm and the driven rod are coupled to a lift beam of the support device; and the lift trolley is hinged to the lift arm; the limit device is composed of a brake block and a limit rack, wherein the brake block is hinged to the lift trolley; and the support device includes a lift beam and a tire lifting frame disposed on both sides of the support device, and the tire lifting frame is installed at both ends of the lift beam.

2. The lawn mower lifting machine of claim 1, wherein the limit device is comprised of a brake block, a limit rack and a retractor; the brake block is comprised of a main beam, two side plates and a limit plate, and an included angle of 120˜150° is formed between the limit plate disposed at the top end of the main beam and the main beam, and both sides of the main beam are fixed to the two side plates respectively, and each of the two side plates has a bolt hole; the brake block is hinged to the lift trolley; the lift trolley is a door-shaped structure comprised of a crossbeam and vertical plates disposed on both sides, and two perforated lugs are disposed below the middle of the crossbeam; the brake block is hinged to the lift trolley by passing a bolt through bolt holes of the two side plates and through holes of two perforated lugs of the door-shaped structure of the lift trolley and sheathing a self-locking nut on a threaded end of the bolt; the limit rack is fixed to the jack installing board which is formed by engaging two boards and has a cross-section in an inverted L-shape; one of the boards facing the rear is used for installing the jack, and the other board facing the front is fixed to the limit rack; the limit rack has a plurality of horizontally arranged rectangular teeth or saw-shaped teeth, and the number of teeth ranges from 1 to 4; the front end of the retractor is a hook, and the rear end of the retractor is a retaining ring; the lift trolley has a perforated retractor holder, and the retaining ring at the rear end of the retractor is buckled into a hole of the retractor holder; and the brake block has a retractor hole formed on a side plate of the brake block.

3. The lawn mower lifting machine of claim 1, wherein the tire lifting frame includes a tire frame and a coupling bar, and the tire frame is rectangular frame formed by a triangular plate, two inverted V-shaped angle bars arranged opposite to each other and a connecting rod, and the coupling bar is perpendicularly fixed to an external side of the triangular plate of the tire frame, and the coupling bar is a square pipe having 3 to 8 positioning holes formed at the vertical and horizontal directions of the coupling bar respectively, and the lift beam is a steel channel having a plurality of tire frame positioning holes formed at the vertical and horizontal directions of the lift beam respectively, and after the positioning holes of the coupling bar and the tire frame positioning holes of the lift beam are aligned, a bolt or an insert pin is used for positioning.

4. The lawn mower lifting machine of claim 1, wherein the jack is a hydraulic jack comprising a jack body, a pedal coupled to the jack body by screws, and an unloading springboard coupled to the jack body by insert pins, and the jack is mounted to the jack installing board by screws, and the unloading springboard has a safety R pin.

5. The lawn mower lifting machine of claim 1, wherein the top of the piston of the jack is coupled to the lift trolley of the lifting device by means of a through hole formed at the top end of the piston of the jack, and the lift trolley is a door-shaped structure comprised of a crossbeam and a vertical plate disposed on both sides, and two perforated lugs are disposed under the middle of the crossbeam, and the piston of the jack is situated at the middle of the two perforated lugs of the door-shaped structure of the lift trolley, and a bolt is passed through the through hole formed at the top end of the piston of the jack and the two perforated lugs of the lift trolley door-shaped structure, and a self-locking nut is sheathed on a threaded end of the bolt.

6. The lawn mower lifting machine of claim 1, wherein the lift arm, the driven rod, the lift beam and the frame lifting device constitute a parallelogram, and the lift arm is a H-shaped structure comprised of two lift rods and a crosspiece, and the lift rod has a reinforcing plate installed thereon and a lift trolley installing hole formed on the reinforcing plate, and a through hole is formed separately at both ends of the lift rod, and the lift trolley is a door-shaped structure comprised of a crossbeam and a vertical plate disposed separately on both sides of the lift trolley, and a through hole is formed at a distal end of the vertical plate, and the driven rod is installed on both sides, such that each lift rod operates with a corresponding driven rod, and the driven rod has a through hole formed separately at both ends of the driven rod, and the lift trolley installing hole and the through holes at distal ends of the vertical plates are coupled by a pin shaft or a bolt to hinge the lift trolley to the lift arm.

7. The lawn mower lifting machine of claim 1, wherein the lift beam has two perforated lift arms disposed at both distal sides of the lug respectively, and the through hole at the top end of the lift rod of the lift arm and the hole of the lug of the perforated lift arm on a side of the lift beam are hinged by a pin shaft or a bolt, and a driven rod lug is disposed under each end of the lift beam, and the driven rod lug has a pin shaft, and the through hole formed at the top end of the driven rod is sheathed on the pin shaft and limited by the elastic snap ring.

8. The lawn mower lifting machine of claim 1, wherein the frame is a rectangular frame with a fixed beam added in the middle, and the jack installing board is formed by engaging two boards and has a cross-section in an inverted L-shape, and one of the boards facing the rear is used for installing the jack and has a jack installing screw hole formed thereon, and the other board facing the front is fixed to the limit rack, and an end of the jack installing board is fixed to the fixed beam and the other end of the jack installing board is fixed onto the rectangular frame of the frame, and a wheel is installed on both left and right sides of the rear of the rectangular frame of the frame, and mounted to the frame by bolts, and a gasket is included between the wheel and the bolt, and a lift arm installing holder which is a rectangular block installed separately on both left and right sides of the frame and has a lift arm installing hole formed at the middle, and a driven rod installing hole is formed separately on both sides of the frame.

9. The lawn mower lifting machine of claim 1, wherein the door-shaped structure of the lift trolley has a trolley hole formed at the middle, a pin hole disposed laterally with respect to the trolley hole, and a through hole is formed at an end of the trolley, such that the trolley can be inserted into the trolley hole, and the insert pin is inserted into the pin hole of the trolley hole and the through hole of the trolley, and a safety R pin is provided for locking, and a handlebar is perpendicularly installed at the other end of the trolley, and the trolley is situated precisely at the center of the handlebar, and a handle sleeve is sheathed separately at both ends of the handlebar.
